(19) United States
(12) Patent Application Publication
(10) Pub. No.: US 2007/0110852 A1
(43) Pub. Date: May 17, 2007

(54) System and method for packaging coffee or tea

(76) Inventor: Fedor Gouverneur, Merida (VE)

Correspondence Address: KING & SCHICKLI, PLLC, 247 NORTH BROADWAY, LEXINGTON, KY, 40507, US

(21) Appl. No.: 10/584,433

(22) PCT Filed: Dec. 17, 2004
(86) PCT No.: PCT/IB04/04211

§ 371 Date: Jun. 22, 2006

Related U.S. Application Data
(60) Provisional application No. 60/530,921, filed on Dec. 22, 2003.

(51) Int. Cl. A23B 7/148

(52) U.S. Cl. 426/106

(57) ABSTRACT

A package for packaging coffee or tea particulate includes (a) a pouch filled with particulate; and (b) a two-piece, pressurizable can comprised of a first, cup-shaped portion having an opening, and a second disk-shaped piece for covering the opening. The pouch is packaged inside the cup-shaped portion and sealed therein by the second disk-shaped portion so as to contain the pouch. Optionally, the particulate is sealed in a CO₂ environment under pressures exceeding ambient pressure. Optionally, several of such packages are packaged together in a multipurpose sleeve. The invention permits the flavor of the particulate to be dispensed discretely as consumed, thus preserving the flavor for a long as possible.

### BACKGROUND OF THE INVENTION

This invention relates to systems and methods for packing, and more particularly, to systems and methods for packaging coffee and/or tea.

Coffee and tea, a filtered particulate most often used to flavor hot water, has been packaged in various forms, including in cans under vacuum, in sachets, in woven or cellulous filters, and canvas and/or paper sacks, among other means.

These prior art means are adequate to transport the particulate to the final point of use. However, such methods fail in preserving the freshness and flavor of such particulate. This is primarily because prolonged exposure to air causes oxidization which often has an undesirable effect on the taste of the beverage made using the particulate. Means have been devised to attempt to limit this oxidation, including, for example, canning the particulate under a vacuum to minimize the amount of air in contact with the particulate, and hermetically sealing the particulate in a CO₂ atmosphere. However, the method of packaging using a vacuum tends to draw (i.e., vacuum) the flavor out of the particulate, and the packing in a CO₂ atmosphere at ambient pressure does not adequately preserve the flavor of the particulate.

U.S. Pat. No. 4,966,780 to Hargraves et al, the content of which is incorporated by reference hereto, describes a container for packaging coffee which is to be packed quickly after roasting, and comprises a semi-rigid, substantially gas impervious container capable of withstanding the pressures generated by the release of gases from the coffee in the container. However, this system does not provide for dispensing of the particulate in quantities that better correspond to the immediate demand because once opened, the entire contents, even that which will not be immediately used, begins to oxidize. Further, the Hargraves device includes an elaborate and complicated way of dealing with the aspiration of the particulate upon opening of a pressurized container.

U.S. Pat. No. 5,445,291 to Daniel, the content of which is incorporated herein by reference thereto, provides a package such as a cylindrical can for containing a particulate product under pressure. This device also includes a rather elaborate device for releasing the pressure without ejecting particulate when opened using a can opener for example.

U.S. Pat. No. 5,344,662 to Payne et al, the content of which is incorporated herein by reference thereto, provides a package containing particulate product under pressure which releases upon opening with an ordinary can opener. This device too uses a rather complicated system to prevent particulate from being aspirated out of the can on opening and into the ambient air.

Nestle S A of Vevey, Switzerland offers a product under the trademark “NETSPRESSO”™, which preserves ground coffee is an aluminum, hermetically sealed capsule. Nestle's promotional material asserts that when ground coffee is contained in the freshness of the coffee is preserved for 6 months, which is considerably longer than the normal period of oxidation of freshly ground coffee, normally considered to be about three days. However, this system does not include packaging the ground coffee under pressure, although some pressure may be present in the capsule due to differential cooling after sealing.

What is needed is a system and method capable of storing particulate under pressure in quantities that permit more discrete dispensing of the particulate, and which also avoid the aspiration of the particulate on opening.

### SUMMARY OF THE INVENTION

A system and method for packaging coffee or tea is provided. The packaging system includes a two-piece can into which a pouch of filter material, filled with the particulate, is inserted. The pouch is optionally inserted into a first cup-shaped piece of the can, under pressure and then the can sealed by sealingly attaching a second, disk-shaped piece of the can over an opening, thus substantially retaining the pressure through transportation until such time as the can is opened by the user. In an embodiment of the packaging system, multiple cans may be stored in a transparent, semi-rigid sleeve, stacked lengthwise, one on top of the other.

In another feature, the sleeve can be made of two telescoping sleeves, each having a shoulder portion, so as to retain the number of cans remaining, and thus not taking up as much space.

In another feature, the sleeve can be printed thereon and thus include further information about the particulate and the advantages of the packing system itself.

In another feature, the sleeve stores cans as well as cups for drinking coffee or tea.

An object of the invention is to permit the storage of particulate under pressure in quantities that permit more discrete dispensing of the particulate, and which also avoid the aspiration of the particulate on opening.

### BRIEF DESCRIPTION OF THE DRAWINGS

FIG. 1 is a partial cross-sectional view of the package of the invention.

FIG. 2 is a partial cutaway, perspective view of the disk-shaped top of the package of the invention.

FIG. 3A is a side view of a packaging system of the invention.

FIG. 3B is a cross section view of the system shown in FIG. 3A, along line A-A.

FIG. 4 is a perspective view of an alternate packaging system of the invention.

FIG. 5 is a perspective view showing a method of use of the invention.

FIG. 6 is a process flow chart of a method of making the package of the invention.

### DETAILED DESCRIPTION OF THE PREFERRED EMBODIMENTS

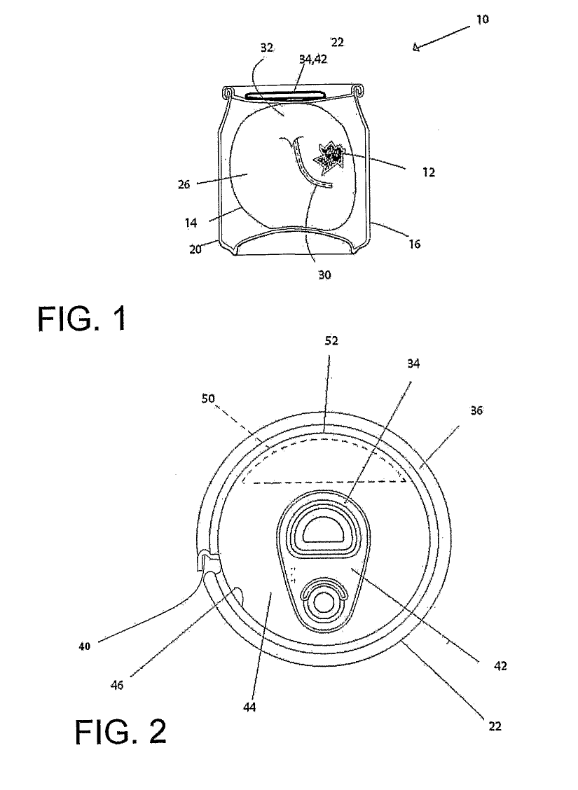

Referring now to FIG. 1, a package 10 for packaging coffee or tea particulate 12 is provided. The package 10 includes (a) a pouch 14 filled with particulate 12; and (b) a two-piece, pressurizable can 16. The can 16 is preferably substantially of known form, drawing its basic shape (in particular, diameter and end forms) and composition (aluminum or steel or other alloys) from standards in producing common pressurized beverage cans well known in the art. Although the can 16 has a diameter and profile consistent with standards for two piece beverage cans having a first, cup-shaped portion 20 with an opening 21, and a second disk-shaped portion 22 for covering the opening, the amount of material to be extruded will vary from the standard as the height of the preferred can is significantly less than the standard, being reduced to from approximately 3.5 cm to 4.5 cms. Use of a standard diameter and form permits the application of commonly known and proven methods of manufacturing for such cans 16. The pouch 14 is packaged inside the cup-shaped portion 20 and sealed therein by the second disk-shaped portion 22 so as to contain the pouch. Optionally, the pouch 14 is sealed in a CO₂ environment under pressures significantly exceeding 1 atmosphere of pressure.

The particulate 12 is contained in the pouch 14 so as to be sealed in the pouch. The pouch 14 is made of filter material 26 of porous paper, cellulous, or woven materials, constructed of material of sufficient thickness and using seaming technology that produces a seam 30 sufficiently strong to withstand the stresses induced upon opening the package 10. Seaming technology such as ultrasonic stitching or the like, or use of a threaded stitch, are suitable. Further, to minimize the likelihood of a burst seam 30 causing the ejection of particulate 12, the pouch 14 is placed in the can so that only an unseamed area 32 is adjacent the opening.

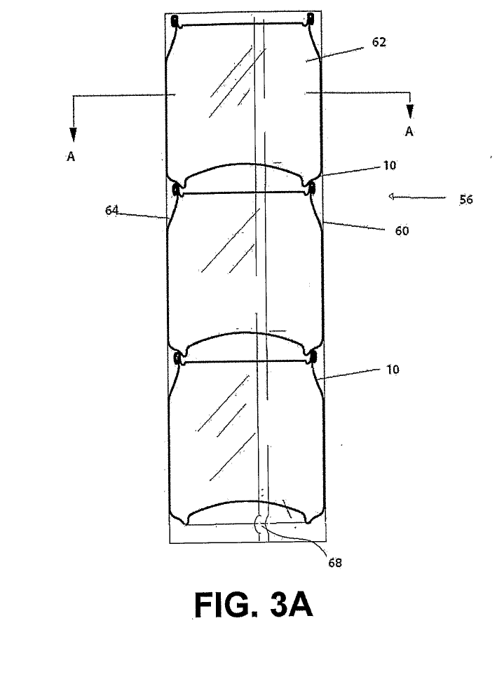

Referring now to FIG. 2, the disk-shaped portion 22 of the can 16 includes a device 34 enabling the opening of the can, as well as an interfacing sealable edge 36, potentially with a rolled-over portion 40 (shown best by break-away portion of the disk), so as to permit connection to and sealing with the cup-shaped portion 20 of the can 16. Optionally, the device 34 comprises a high-stress inducing handle or tab portion 42 connected near the edge of an area 44 of the disk which is circumscribed by a reduced thickness portion 46 of material. In such a device 34, lifting of the tab 42 induces stress after a stress-inducing movement of the tab is made, so as to initiate a rupture in the reduced thickness portion 46 of the material and to provide any pressurized air with an opportunity to escape. The reduced thickness portion 46 causes peeling back of the circumscribed area 44 along an opening path that, after opening is complete, creates an opening sufficiently large to enable the pouch 14 to be removed from the can 16 without difficulty. Optionally, to facilitate recycling, the tab 42 and panel 44 removed from the disk-shaped portion 22 to create the opening remains attached to the can 16 via a non-reduced thickness or only marginally reduced thickness portion 50 (shown by dashed lines) connected to a rim 52 of the disk-shaped portion 22.

In a preferred embodiment, existing two-piece can technology for making liquid filled beverage cans is used. The cans 16 are ideally cylindrical, about 4.5 cm in length (approximately half the size of the small 7 oz cans offered on airplanes for example) and would each contain 60 grams of ground coffee. This is sufficient for 4 to 6 cups of coffee (at 10-12 grams per 100 milliliters of water).

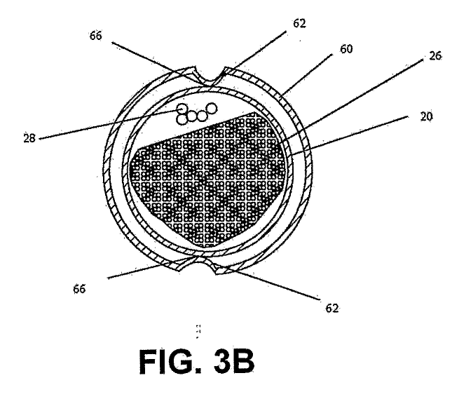

Referring now to FIGS. 3A and 3B, optionally, the package 10 may itself be packaged together with other such packages, in a system 56 including a sleeve 60. At least two packages 10 may be inserted inside the sleeve 60. Each package 10 is stored within the sleeve 60 in a longitudinal orientation.

Referring particularly to FIG. 3B, the sleeve 60 is optionally made of an extruded form having longitudinal, inwardly extending ribs 62 which reduce the maximum internal inscribed diameter so as to cause the ribs to grip against the inserted packages 10, or other inserted objects such as a cup 64. The friction created by this interference fit 66 retains the packages 10 within the sleeve 60 yet allows a user to insert a spent package in one end, thus dispensing a new package through the other end of the sleeve for use in brewing coffee or tea. A localized divot 68 can me molded or formed in an end of a rib 62 so as to prevent the can 16 from easily dispensing from the bottom of the sleeve 60.

In one embodiment, the sleeve 60 is transparent and semi-rigid. The transparent feature of the sleeve 60 allows a user to quickly see how many cans 16 are contained within the sleeve. The semi-rigid feature enables the sleeve 60 to be easily crushed or compacted during a recycling operation.

In another embodiment, the sleeve 60 is made of the same material as the can 16, so as to enable used cans to be placed back in the sleeve and the entire assembly to be recycled together.

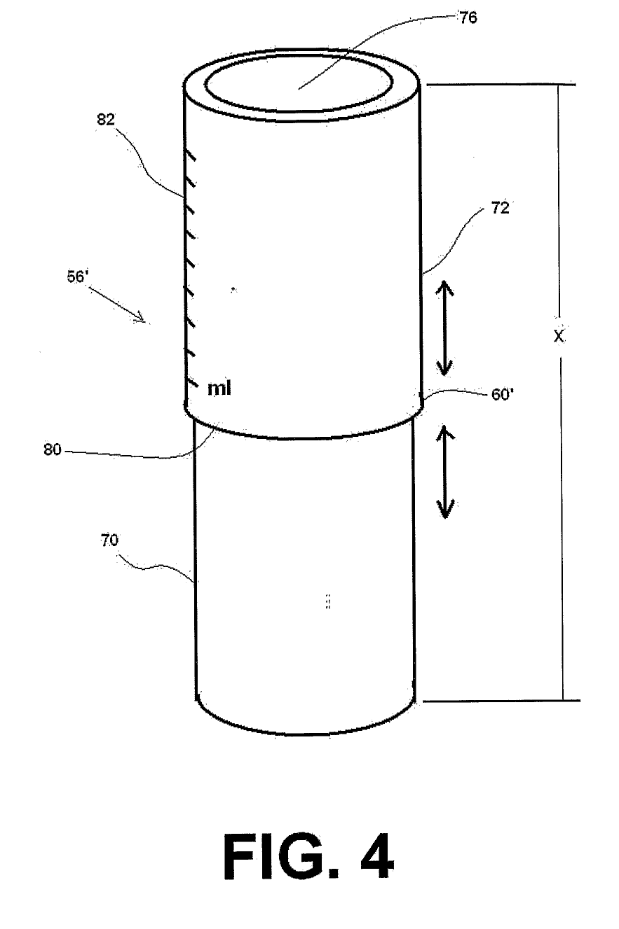

Referring now to FIG. 4, in another embodiment of the system 56′, the sleeve 60′ comprises an inner portion 70 and outer portion 72. The portions 70 and 72 fit so as to telescope thus enabling adjustment of the height and thus the package storage capacity of the sleeve 60′. At least one of the portions 70 or 72 is transparent and cup shaped, having a closed end 76 and an open end 80. Measuring marks 82 are interspersed along its length, so as to serve as a measuring beaker for liquid, such as water, required for making a desired amount of coffee at a desired strength.

The package 10 and the sleeve 60 or sleeve portions 70 or 72 are made of a printable material.

In a first method of use, the cans 16 merely contain the pouch 14 of ground coffee or tea until the time of dispensing by a user. The can 16 is opened using the tab or handle 42, the lid pulled away, the pouch 14 removed and then placed in a drip coffee maker or other known brewing device.

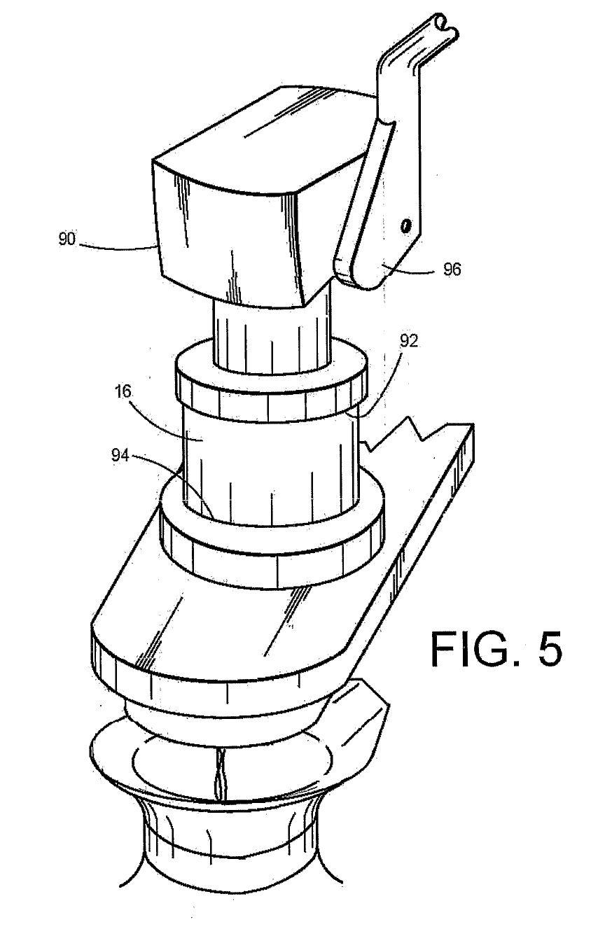

Referring now to FIG. 5, in a second method of use, the can 16 functions as a cartridge which is placed inside a clamping holder 90 which first seals the ends 92 and 94 of the can against mechanical pressure, and then punctures the ends, thus providing a hot water flow path through the pouch contained in the can. When the cartridge 16 is spend (after having brewed 4 cups of coffee), the clamping holder mechanism 96 is deactivated, and the spent cartridge removed from the brewing device 90. This way, the need for separate filters is eliminated and the design of the brewing device can be simplified.

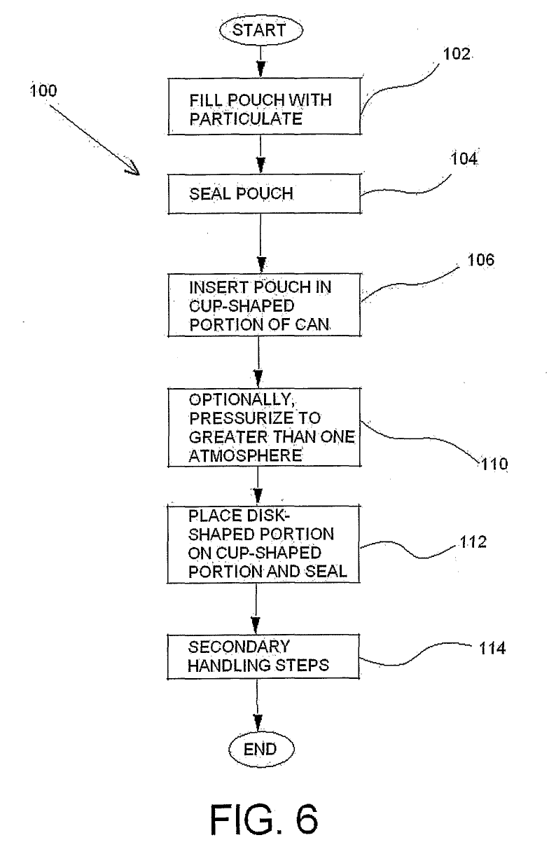

Now referring to FIG. 6, a method 100 of packaging tea or coffee particulate comprises the following steps. In a first step 102, a filter pouch 14 is filled with particulate 12. In a second step 104, the pouch 14 is sealed. In a third step 106, the pouch 14 is inserted into a first, cup-shaped portion 20 of a two-piece, pressurizable can 16. In an optional fourth step 110, the atmosphere local to the can 16 is increased above one atmosphere. The sealing may take place in several similar manners. In a first variation, the can 16 is sealed in a pressurized CO₂ environment, so that, once sealed, the can 16 is pressurized with CO₂ gas. This is made possible by, for example, either locally increasing the pressure in the immediate vicinity of the can by for example, isolating the can in a CO₂ rich, high pressure chamber during the sealing step, by inserting frozen CO₂ pellets 28 in the can prior to sealing, or by injecting the can with high pressure CO₂ after it is sealed. In a fifth step 112, the pouch 14 is sealed inside the cup-shaped portion 20 by a second disk-shaped portion 22 of the can 16 so as to contain the pouch. In subsequent steps 114, secondary handling takes place, such as packaging in the system 54 of the invention, printing, and distribution to the ultimate user.

Referring to the pressurizing step above involving the insertion of dry ice pellets 28, the can 16 is charged with a pellet of dry ice (preferred) or other solid or liquefied gas such as liquid nitrogen as it is assembled. By charging the can 16 before sealing, it is possible for the pressure inside the can to build up to superatmospheric pressures as the dry ice sublimates into CO₂ gas, substantially displacing the oxygen in the can. Use of dry ice in this manner is described in U.S. Pat. No. 5,620,725, the content of which is incorporated by reference thereto. Further, because the ground coffee is placed in a separate pouch 14, there is no direct contact between the coffee or tea particulate 12 and the dry ice pellet 28. Further, the dry ice pellets 28 are conveyed to the can 16 via a number of known procedures, including, for example, that described in U.S. Pat. No. 5,761,888, the content of which is incorporated herein by reference thereto.

It should be noted that the can 16 must be capable of withstanding the pressures generated by the Carbon Dioxide diffused/emitted by freshly roasted coffee. The typical two piece beverage is suitable for this purpose, depending on the quantity of roasted coffee stored therein and the temperature at which the can 16 is stored. Technical parameters helpful in determining the amount of coffee which can safely be stored in a common, two piece beverage can, particularly of the single serving size, may be obtained in the article by B. A. Anderson and T. P. Lebuza et al, entitled The Diffusion Kinetics of Carbon Dioxide in Fresh Roasted and Ground Coffee (see http://faculty.che.umn.edu/fscn/Ted_Labuza/tpl-coffee.html), the content of which is incorporated by reference thereto. As already noted, it is advantageous to use a standard two-piece beverage can in order to take advantage of the infrastructure in place in the beverage industry to can the particulate and distribute the package 10 of the invention. Further, it should be noted that cooling the package 10 reduces the pressure therein and increases the amount of outgassing due to oxidation that the package can safely withstand. The beverage distribution industry conveniently supports transportation of refrigerated product and thus, provides another basis for using a standard two-piece beverage can.

In another feature, the sleeve 60, 60′ can be printed thereon and thus include further information about the particulate 12 and the advantages of the packing system 56 itself.

In another feature, the sleeve 60 stores cans 16 as well as cups 64 for drinking coffee or tea.

An object of the invention is to permit the storage of particulate 12 under pressure in quantities that permit more discrete dispensing of the particulate, and which also avoid the aspiration of the particulate upon opening.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

1. A package for packaging coffee or tea particulate is provided, the package comprising:
(a) a pouch filled with the particulate; and
(b) a two-piece, pressurizable container having a closed-ended cylindrical body sealingly closeable by a cap via a method of rolling edges of the parts together, wherein the pouch is packaged inside the container, in a CO₂ environment under pressure exceeding ambient pressure, and hermetically sealed therein.

2. (canceled)

3. (canceled)

4. The package of claim 1, wherein the two-piece container is a can comprised of a first, cup-shaped portion having an opening, and a second covering piece having a shape corresponding to the opening for covering the opening, wherein the pouch is packaged inside the cup-shaped portion, in a CO₂ environment under pressure exceeding ambient pressure, and hermetically sealed therein by sealingly engaging the second covering piece with the opening of the cup-shaped portion.

5. (canceled)

6. The package of claim 4, wherein the second covering piece is disk-shaped and includes an opening tab to facilitate opening of the container, thus permitting access to the pouch.

7. The package of claim 1, wherein the particulate is sealed in the pouch.

8. The package of claim 1, wherein the pouch is made of filter material.

9. The package of claim 8, wherein the filter material is selected from a group of materials consisting of porous paper, porous cellulous, and porous woven material constructed so as to be sufficiently strong to withstand the stresses induced upon opening the package.

10. The package of claim 1, wherein such package is formed so as to be efficiently packagable together with other such packages, in a system including a sleeve, wherein at least two packages may be inserted inside the sleeve.

11. The package of claim 10, wherein the package is stored within the sleeve in a longitudinal orientation.

12. The package of claim 10, wherein the sleeve is transparent and semi-rigid.

13. The package of claim 10, wherein the sleeve comprises an inner and outer portion, the portions telescoping so as to adjust the height and thus the package storage capacity of the sleeve.

14. The package of claim 13, wherein at least one of the portions is transparent and cup shaped, having a closed end and an open end, and measuring marks interspersed along its length, so as to serve as a measuring beaker for liquid, such as water.

15. The package of claim 10, wherein the sleeve is made of a printable material.

16. A method of packaging tea or coffee particulate, the method comprising the steps of:
(a) filling a filter pouch with particulate;
(b) closing the pouch;
(c) inserting the filled filter pouch through an opening into a first, cup-shaped portion of a two-piece, pressurizable container; and
(d) hermetically sealing the pouch inside the cup-shaped portion by sealing a second, covering portion over the opening wherein the sealing seals CO₂ gas at a pressure above ambient pressure into the container.

17. (canceled)

18. The method of claim 16, wherein, prior to sealing, dry ice is placed inside the container.
